(19) United States
(12) Patent Application Publication
(10) Pub. No.: US 2005/0287955 A1
(43) Pub. Date: Dec. 29, 2005

(54) System of increasing communication quality of PHS handset by employing bluetooth

(75) Inventors: Cheng-Shing Lai, Taipei Hsien (TW); Jun Zhu, Nanking (CN); Yong-Cai Bian, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/873,198

(22) Filed: Jun. 23, 2004

(51) Int. Cl. H04B 7/00

(52) U.S. Cl. 455/67.13; 455/41.2

(57) ABSTRACT

The present invention is to provide a system of increasing communication quality of a PHS handset in a PHS-based communication network including a plurality of PHS handsets each including a first bluetooth module, an indoor Internet phone including a second bluetooth module and a gateway coupled to the second bluetooth module and two different protocols. When the first bluetooth module is connecting to the second bluetooth module, signals received from the network by the Internet phone are transmitted to the gateway and then converted into signals complying with a bluetooth protocol, enabling the second bluetooth module to transmit the same to the PHS handset. The PHS handset is also able to transmit signals complying with the bluetooth protocol to the Internet phone, enabling the gateway to convert the same into the PHS signals and transmit them over the network.

### FIELD OF THE INVENTION

The present invention relates to PHS (Personal Handyphone System), more particularly to a system of increasing communication quality of a PHS handset by employing bluetooth module thereto and utilizing the superior short distance signal communication of the bluetooth protocol to increase the communication quality of the PHS handset, enabling the PHS handset to make a call even in a poor communication indoor environment.

### BACKGROUND OF THE INVENTION

PHS is a portable low power cellular phone developed by Japan NTT Corporation. PHS handset is also called little cellular phone in Taiwan. PHS handsets have applications in a slow movement environment due to low power. Conventionally, transmission power of a base station of PHS is no more than 32 W, frequency thereof is in the range of 1,895 MHz to 1,918 MHz, and data transfer rate thereof is in the range of 64 Kbps to 128 Kbps. In view of the above data, a person driving on a highway in a speed no more than 120 Km per hour still can use a PHS handset to send e-mails, pictures, messages, etc. since signals can be received or transmitted without interference.

Moreover, PHS has features of low power, large system capacity, and high data transmission rate. Thus, PHS is particularly suitable for metropolises. Also, its charge is relatively low, electromagnetic interference is very small, and its Internet access rate is about 64 Kbps. Most importantly, its design is diversified. PHS handsets are widely popular among young people due to above reasons since its availability on the market.

However, PHS also suffered from several disadvantages such as low power, weak signal, disconnection-prone, highly dense base stations required, and poor communication quality particularly in an indoor environment. Hence, a need for improvement exists.

### SUMMARY OF THE INVENTION

A primary object of the present invention is to provide a system of increasing communication quality of a PHS handset by employing bluetooth in a PHS-based communication network including a plurality of PHS handsets each including a first bluetooth module, an indoor Internet phone including a second bluetooth module and a gateway coupled to the second bluetooth module and two different protocols. When the first bluetooth module of one of the PHS handsets is connecting to the second bluetooth module of the Internet phone, signals received from the network by the Internet phone are transmitted to the gateway and then converted into signals complying with a bluetooth protocol, enabling the second bluetooth module to transmit the signals complying with the bluetooth protocol to the PHS handset. The PHS handset is also able to transmit signals complying with the bluetooth protocol to the Internet phone, enabling the gateway to convert the signals complying with the bluetooth protocol into the PHS signals and transmit the PHS signals over the network. By utilizing the bluetooth protocol of the present invention, interference is avoided, communication quality of the PHS handsets is increased in a short distance signal communication, and each of the PHS handsets still can make a call even in an indoor environment. Moreover, by utilizing the present invention, the above drawbacks of the prior art can be overcome. These drawbacks are that low power, weak signal, disconnection-prone, highly dense base stations required, and poor communication quality particularly in an indoor environment.

One object of the present invention is that the gateway of the Internet phone is further connected to a PSTN or LAN network, and when the first bluetooth module of one of the PHS handsets is connecting to the second bluetooth module of the Internet phone, one of the PHS handsets is operative to access the network for making a call, doing one of a plurality of predetermined operations or transferring data even if the default PHS of the handset is not in use or is malfunctioned.

Another object of the present invention is that each of the PHS handsets further comprises a communication interface (e.g., USB interface, UART interface, etc.), one of the PHS handsets is connected to a computer via the communication interface, and when the first bluetooth module of one of the PHS handsets is connecting to the second bluetooth module of the Internet phone, the computer is connected to the PHS handset for accessing the network, sending data to a predetermined called party, or receiving data stored in a memory for viewing via the PHS handset.

Still another object of the present invention is that the second bluetooth module of the Internet phone is operative to connect to seven PHS handsets each including a bluetooth module simultaneously, and when the first bluetooth module of one of the PHS handsets is connecting to the second bluetooth module of the Internet phone, a Pico net is established among the Internet phone and the PHS handsets. Hence, the PHS handsets can communicate with each other via the Internet phone. Also, each of the PHS handsets can access the network for making a call or doing other operations (e.g., data receiving, data sending, or downloading documents from the Internet) by means of the Internet phone. Further, one of the PHS handsets can roam to another Internet phone having an embedded bluetooth module for connecting thereto.

The above and other objects, features and advantages of the present invention will become apparent from the following detailed description taken with the accompanying drawings.

### BRIEF DESCRIPTION OF THE DRAWINGS

FIG. 1 presents schematically the connection of a PHS-based communication network according to the invention;

FIG. 2 is a flow chart illustrating a process of establishing a connection between an Internet phone and a PHS handset according to the invention;

FIG. 3 is a flow chart illustrating a process of establishing a connection between a PHS handset and an Internet phone according to the invention;

FIG. 4 is a flow chart illustrating a process of receiving a call from the PHS handset by the Internet phone according to the invention;

FIG. 5 is a flow chart illustrating a process of receiving a call from the Internet phone by the PHS handset according to the invention;

FIG. 6 is a flow chart illustrating a process of ending a call by the Internet phone according to the invention;

FIG. 7 is a flow chart illustrating a process of connecting to the Internet phone via the PHS handset according to the invention;

FIG. 8 is a flow chart illustrating another process of connecting to the Internet phone via the PHS handset according to the invention;

FIG. 9 is a flow chart illustrating a process performed by the Internet phone when the PHS handset is leaving the coverage of bluetooth communication according to the invention; and

FIG. 10 is a flow chart illustrating another process performed by the PHS handset when the PHS handset is leaving the coverage of bluetooth communication according to the invention.

### DETAILED DESCRIPTION OF THE PREFERRED EMBODIMENTS

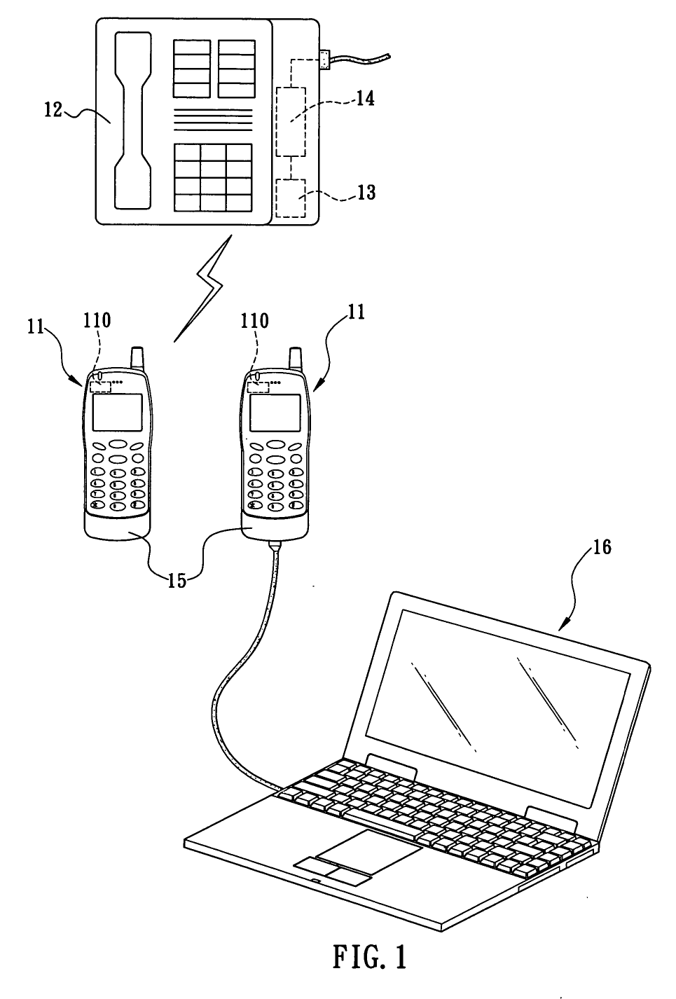

Referring to FIG. 1, there is shown a system of increasing communication quality of a PHS handset by employing bluetooth in accordance with the invention. The system is implemented in a PHS-based communication network comprising a plurality of PHS handsets 11 having an embedded bluetooth module 110, an indoor Internet phone 12 including a second bluetooth module 13 and a gateway 14 coupled to the second bluetooth module 13 and two different protocols (i.e a corresponding network protocol and a bluetooth protocol). In a case of the bluetooth module 110 of the PHS handset 11 is connecting to the second bluetooth module 13 of the Internet phone 12, signals received from the network by the Internet phone 12 are transmitted to the gateway 14 and then converted into signals complying with a bluetooth protocol, enabling the second bluetooth module 13 to transmit the signals complying with the bluetooth protocol to the PHS handset 11. The PHS handset 11 is also able to transmit signals complying with the bluetooth protocol to the Internet phone 12, enabling the gateway 14 to convert the signals complying with the bluetooth protocol into the PHS signals and transmit the PHS signals over the network. In such a manner, interference is avoided and communication quality of the PHS handsets 11 is increased in a short distance signal communication by employing bluetooth. As a result, a PHS handset 11 still can make a call even in an indoor environment.

As for bluetooth, it is a wireless communication technique in a short distance (e.g., in the range of 10 to 100 meters). It involves a wireless and RF (radio frequency) chip module for transmitting or receiving signal having a frequency of 2.4 GHz. For avoiding such frequency band from being interfered by other electrical devices, a fast response and frequency jumping system is adopted. Also, encryption is employed for achieving a stable wireless connection. In such small wireless communication area, each of uplink and downlink transfer rates is 432 Kbps in a symmetrical transfer mode. But uplink transfer rate is 56 Kbps and downlink transfer rate is 721 Kbps in a non-symmetrical transfer mode. This configuration can facilitate communication between a PHS and a computer.

Referring to FIG. 1 again, the gateway 14 of the Internet phone 12 is further connected to a network (e.g., PSTN (Public Switched Telephone Network), LAN (Local Area Network), etc.) (not shown). In a case of the bluetooth module 110 of one PHS handset 11 is connecting to the second bluetooth module 13 of the Internet phone 12, a user can access the network for making a call or doing other operations by means of the PHS handset 11. In such a manner, one PHS handset 11 still can access the network for making a call or doing other operations (e.g., data transfer) even if the default PHS (Personal Handyphone System) of the handset 11 is not in use or is malfunctioned.

Referring to FIG. 1 again, the PHS handset 11 further comprises a communication interface 15 (e.g., USB (Universal Serial Bus) interface, UART (Universal Asynchronous Receiver/Transmitter) interface, etc.) The PHS handset 11 can be connected to a computer 16 (e.g., notebook computer, desktop computer or the like) via the communication interface 15. In a case of the bluetooth module 110 of one PHS handset 11 is connecting to the second bluetooth module 13 of the Internet phone 12, the computer 16 connected to the PHS handset 11 is able to access the network or doing other operations (e.g., send data to a specified called party, store received data in memory for future viewing, etc.) via the PHS handset 11.

Referring to FIG. 1 again, in the invention the second bluetooth module 13 of the Internet phone 12 can be connected to seven PHS handsets 11 each having a bluetooth module 110 (only two PHS handsets are shown) simultaneously. In a case of the bluetooth modules 110 of the PHS handsets 11 are connecting to the second bluetooth module 13 of the Internet phone 12, a Pico net is established among the Internet phone 12 and the PHS handsets 11. Hence, the PHS handsets 11 can communicate with each other via Pico net and serve as extensions of the Internet phone 12. Also, each PHS handset 11 can access the network for making phone call or doing other operations (e.g., data receiving, data sending, or downloading documents from the Internet) by means of the Internet phone 12. Further, one of the PHS handsets 11 can roam to another Internet phone having an embedded bluetooth module for connecting thereto.

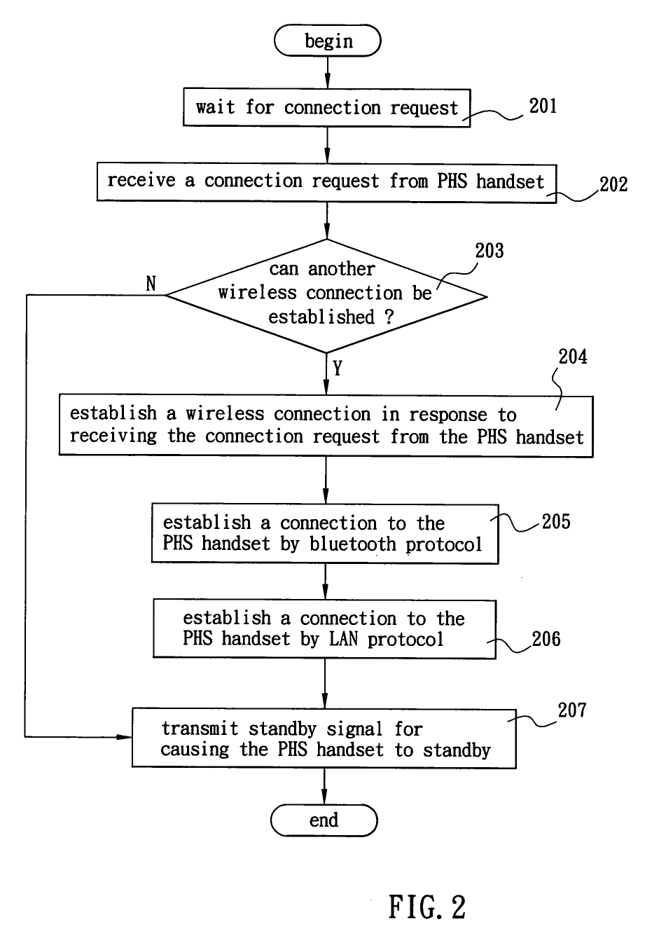

Referring to FIG. 2 in conjunction with FIG. 1, when a connection is being established between the Internet phone 12 and each of the PHS handsets 11 according to the invention, the Internet phone 12 will proceed with a process comprising the following steps:

In step 201, wait for connection request.

In step 202, a connection request from the PHS handset 11 is received.

In step 203, it is determined whether a new wireless connection can be increased. If yes, the process goes to step 204. Otherwise, the process jumps to step 207.

In step 204, establish a new wireless connection in response to the receiving of the connection request sent from the PHS handset 11.

In step 205, establish a wireless connection to the PHS handset 11 by means of the bluetooth protocol.

In step 206, establish a connection to the PHS handset 11 by means of LAN protocol.

In step 207, transmit a standby signal for commanding the PHS handset 11 to enter into a power saving mode. The process ends immediately.

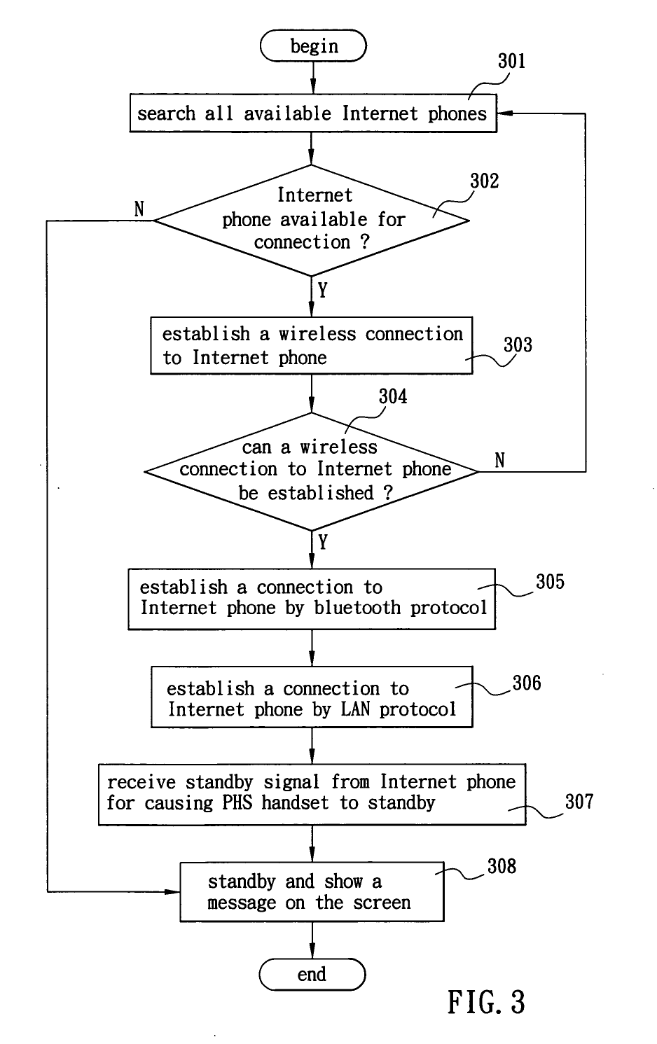

Referring to FIG. 3 in conjunction with FIG. 1, when the connection is being established between the Internet phone 12 and the PHS handset 11 according to the invention, the PHS handset 11 will proceed with a process comprising the following steps:

In step 301, search all available Internet phones 12.

In step 302, it is determined whether there is an Internet phone 12 available for connection. If yes, the process goes to step 303. Otherwise, the process jumps to step 308.

In step 303, establish a wireless connection to the Internet phone 12.

In step 304, it is determined whether it is possible of increasing a new wireless connection to the Internet phone 12. If yes, the process goes to step 305. Otherwise, the process loops back to step 301.

In step 305, establish a wireless connection to the Internet phone 12 by means of bluetooth protocol.

In step 306, establish a connection to the Internet phone 12 by means of LAN protocol.

In step 307, receive a standby signal from the Internet phone 12 so that the PHS handset 11 is commanded to enter into a power saving mode.

In step 308, standby and show a message on the screen for informing a user. The process ends immediately.

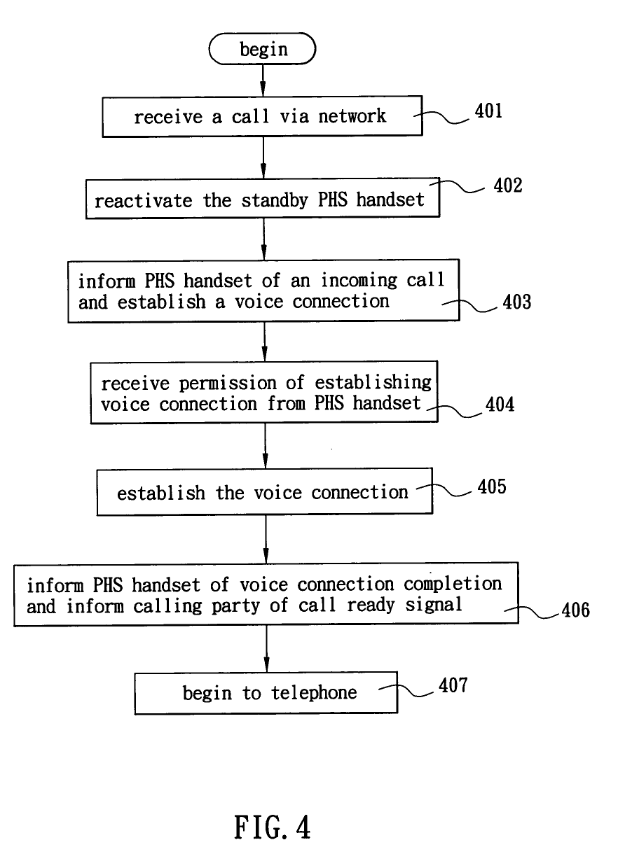

Referring to FIG. 4 in conjunction with FIG. 1, when the Internet phone 12 is receiving a call from the network according to the invention, the Internet phone 12 will proceed with a process comprising the steps as follows:

In step 401, receive a call from a calling party via a network.

In step 402, reactivate the standby status of the PHS handset 11.

In step 403, issue a message to the PHS handset 11 for informing a called party that a call is incoming and begin to establish a voice connection.

In step 404, receive a call from the PHS handset 11 indicating a permission of establishing the voice connection.

In step 405, establish the voice connection.

In step 406, issue a message of voice connection completion to the PHS handset 11 and issue a message of call ready to the calling party via the network.

In step 407, two parties begin to telephone.

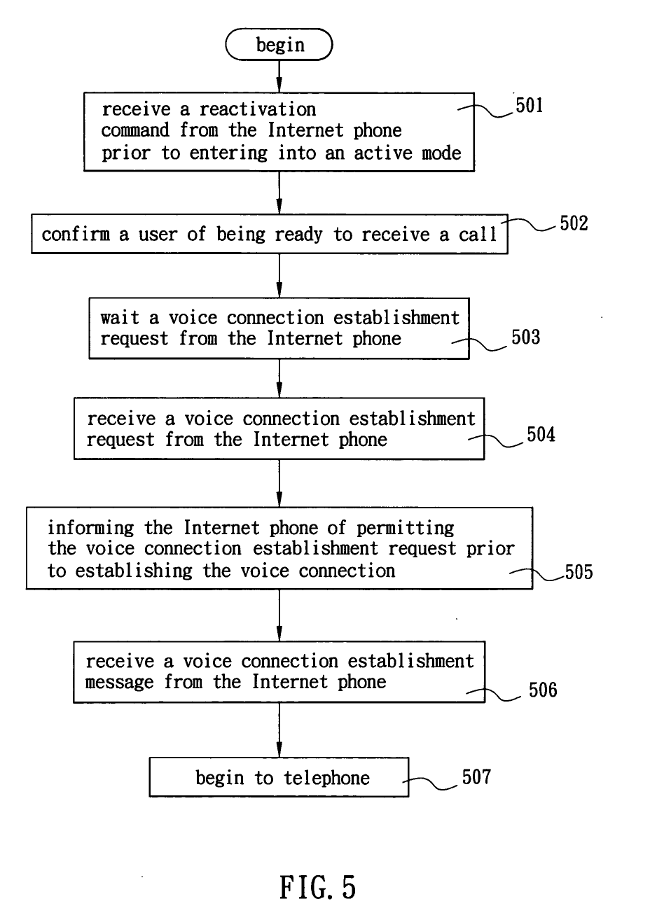

Referring to FIG. 5 in conjunction with FIG. 1, when the Internet phone 12 is receiving the call from the network according to the invention, the PHS handset 11 will proceed with a process comprising the following steps in order to receive the call via the Internet phone 12:

In step 501, receive a reactivation command from the Internet phone 12 prior to entering into an active mode.

In step 502, issue a message of confirming that a user is ready to receive a call.

In step 503, wait a voice connection establishment request sent from the Internet phone 12.

In step 504, receive a voice connection establishment request sent from the Internet phone 12.

In step 505, issue a message to the Internet phone 12 indicating that the voice connection establishment request is permitted prior to establishing the voice connection.

In step 506, receive a message from the Internet phone 12 indicating that the voice connection has been established.

In step 507, two parties begin to telephone.

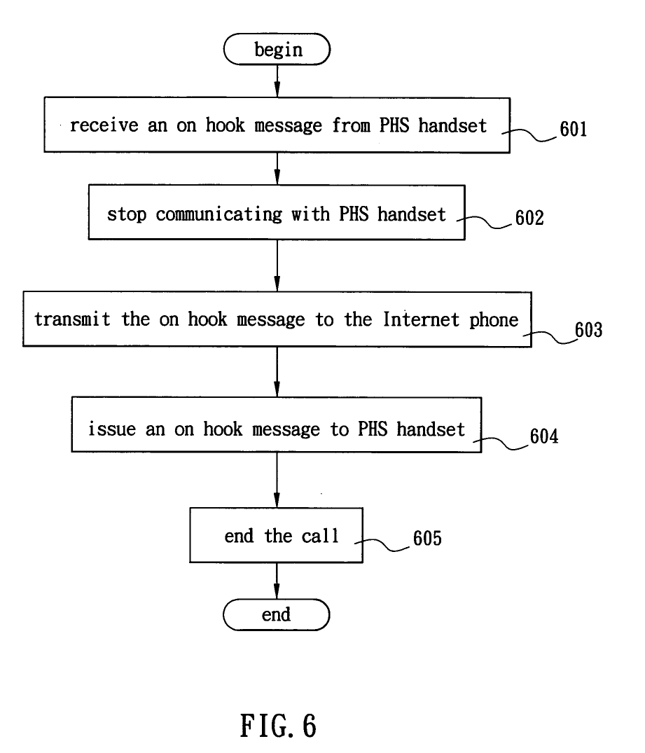

Referring to FIG. 6 in conjunction with FIG. 1, when the PHS handset 11 is hung up according to the invention, the Internet phone 12 will proceed with a process comprising the following steps:

In step 601, receive an on hook message from the PHS handset 11.

In step 602, stop a communication with the PHS handset 11.

In step 603, transmit the on hook message to the calling party via the network.

In step 604, issue an on hook message to the PHS handset 11.

In step 605, end the call.

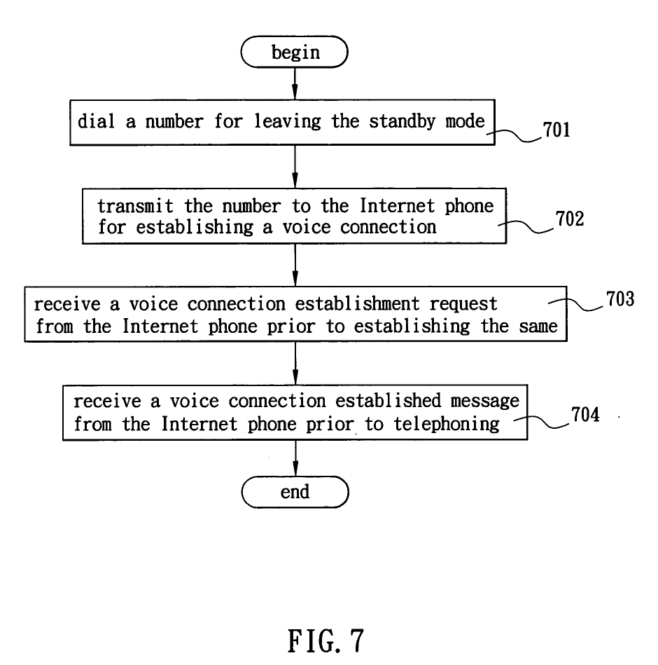

Referring to FIG. 7 in conjunction with FIG. 1, when the PHS handsets 11 is being dialed to make a call via the network according to the invention, the PHS handsets 11 will proceed with a process comprising the following steps:

In step 701, leave the standby mode according to a number being dialed.

In step 702, the dialed number is transmitted to the Internet phone 12 as a first step of establishing a voice connection.

In step 703, receive a voice connection establishment request sent from the Internet phone 12 prior to establishing the voice connection.

In step 704, receive a message from the Internet phone 12 indicating that the voice connection has been established prior to telephoning.

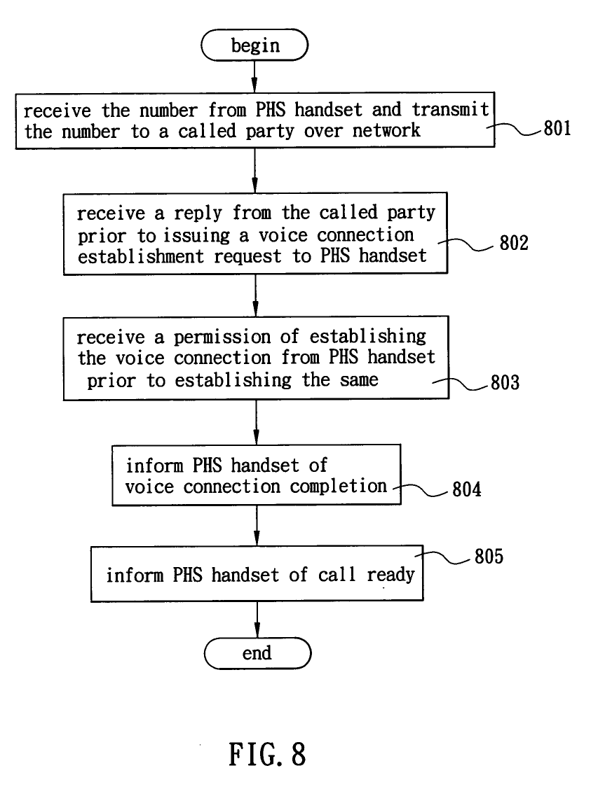

Referring to FIG. 8 in conjunction with FIG. 1, when the PHS handsets 11 is being dialed to make a call via the network according to the invention, the Internet phone 12 will proceed with a process comprising the following steps:

In step 801, receive the dialed number from the PHS handset 11 and transmit the number to a called party over the network.

In step 802, receive a reply from the called party over the network prior to issuing a voice connection establishment request to the PHS handset 11.

In step 803, receive a call from the PHS handset 11 indicating a permission of establishing the voice connection prior to establishing the voice connection.

In step 804, issue a message of voice connection completion to the PHS handset 11.

In step 805, issue a message of call ready to the PHS handset 11.

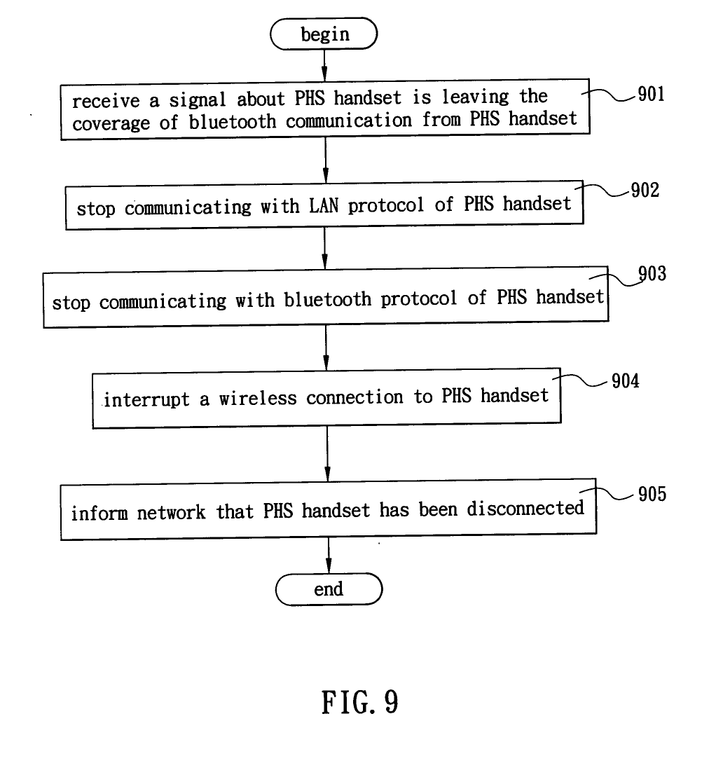

Referring to FIG. 9 in conjunction with FIG. 1, when the PHS handset 11 is leaving the coverage of bluetooth communication according to the invention, the Internet phone 12 will proceed with a process comprising the following steps:

In step 901, receive a signal from the PHS handset 11 indicating that the PHS handset 11 is leaving the coverage of bluetooth communication.

In step 902, stop a communication with the LAN protocol of the PHS handset 11.

In step 903, stop a communication with the bluetooth protocol of the PHS handset 11.

In step 904, interrupt a wireless connection to the PHS handset 11.

In step 905, informing the network that the PHS handset 11 has been disconnected.

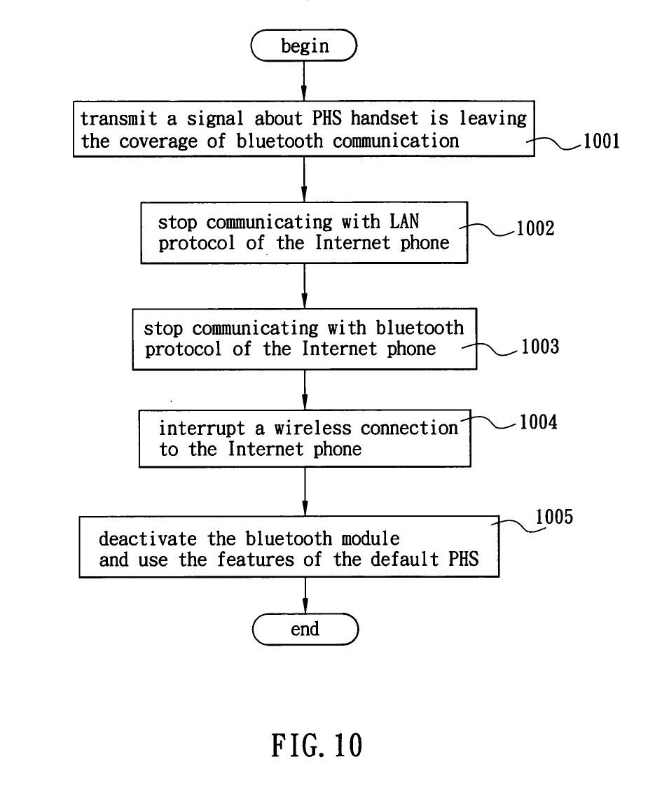

Referring to FIG. 10 in conjunction with FIG. 1, when the PHS handset 11 is leaving the coverage of bluetooth communication according to the invention, the the PHS handset 11 will proceed with a process comprising the following steps:

In step 1001, transmit a signal indicating that the PHS handset 11 is leaving the coverage of bluetooth communication.

In step 1002, stop a communication with the LAN protocol of the Internet phone 12.

In step 1003, stop a communication with the bluetooth protocol of the Internet phone 12.

In step 1004, interrupt a wireless connection to the Internet phone 12.

In step 1005, deactivate the bluetooth module and use the features of the default PHS.

While the invention has been described by means of specific embodiments, numerous modifications and variations could be made thereto by those skilled in the art without departing from the scope and spirit of the invention set forth in the claims.

1. A system of increasing communication quality of a PHS handset by employing bluetooth in a PHS-based communication network including a plurality of PHS handsets each including a first bluetooth module, an indoor Internet phone including a second bluetooth module and a gateway coupled to the second bluetooth module and two different protocols, when the first bluetooth module of one of the PHS handsets is connecting to the second bluetooth module of the Internet phone, the Internet phone receives signals from the PHS-based communication network and then transmits the signals to the gateway; the gateway then converts the signals into signals complying with a bluetooth protocol by means of the protocols and then transmits the signal complying with the bluetooth protocol through the second bluetooth module to the PHS handset.

2. The system of claim 1, wherein the bluetooth module of the PHS handset is able to transmit signals complying with the bluetooth protocol to the gateway of the Internet phone, and the gateway then convert the signals complying with the bluetooth protocol into PHS signals by means of the protocols and transmits the PHS signals over the PHS-based communication network.

3. The system of claim 2, wherein each of the PHS handsets further comprises a communication interface, when one of the PHS handsets is connected to a computer via the communication interface and the first bluetooth module of the PHS handset is connecting to the second bluetooth module of the Internet phone, the computer is operative to access the PHS-based communication network through the PHS handset and the Internet phone.

4. The system of claim 2, wherein the second bluetooth module of the Internet phone is operative to connect to seven PHS handsets each including a bluetooth module simultaneously, and when the first bluetooth module of one of the PHS handsets is connecting to the second bluetooth module of the Internet phone, a Pico net is established among the Internet phone and the PHS handsets.

5. The system of claim 2, wherein the PHS-based communication network is a Public Switched Telephone Network.

6. The system of claim 2, wherein the PHS-based communication network is a Local Area Network.

7. The system of claim 3, wherein the communication interface is a Universal Serial Bus interface.

8. The system of claim 3, wherein the communication interface is a Universal Asynchronous Receiver/Transmitter interface.
